(19) United States
(12) Patent Application Publication
(10) Pub. No.: US 2012/0312127 A1
(43) Pub. Date: Dec. 13, 2012

(54) Device For Resetting Locks

(76) Inventor: Mark Overby Jones, Raleigh, NC (US)

(21) Appl. No.: 13/488,889

(22) Filed: Jun. 5, 2012

Related U.S. Application Data
(60) Provisional application No. 61/520,539, filed on Jun. 11, 2011.

(51) Int. Cl. E05B 19/20

(52) U.S. Cl. 81/15.9

(57) ABSTRACT

A simple, handheld instrument 4 for re-setting multiple brands of user re-settable lock cylinders, including and in particular, Schlage Securekey™ cylinders. The instrument generally comprises a graspable flat piece of steel with one or more multi-tine combs fashioned into the end or ends of the instrument. By guiding the comb into the lock cylinder's access ports and depressing the internal slides of the lock, it is then possible to rotate said cylinder to it's reset position where a new key can be inserted and learned. In addition to a comb or combs fashioned into the handle end, the instrument includes an opposing protruding barb 3 off one end for depressing an internal reset shuttle.

### CROSS REFERENCE TO RELATED APPLICATIONS

Related US application Data: Provisional application No. 61/520,539 filed Jun. 11, 2011

### BACKGROUND OF THE INVENTION

Architectural locks (mainly doorknobs and deadbolts) have changed very little over the years. Until recently, the majority of mechanical locks for architectural applications have relied on pin tumbler technology. Using variable spacing and depth of cut onto a key, this over 100 year old technology has proven reliable, robust, and relatively secure. One drawback to this technology though is that a locksmith is usually required to re-key these locks. The average consumer does not have the pin kit or the expertise to change the keys when necessary.

Around 2006, two of the largest US lock manufacturers, Schlage and Kwikset, addressed this problem by creating a user resettable lock that the average consumer could re-key themselves without removing the lock from the door. Kwikset was first with their Smartkey™ design (U.S. Pat. No. 7,878,036 B2) and Schlage soon followed with their Securekey™ design (patent application no. US 2008/0314106 A1). These are the only two widely produced and distributed user resettable lock designs available now.

One problem with this new user resettable designs is they require the consumer to have the original keys that came with the lock in order to perform a re-set of the lock to a new key. If the consumer were to lose or misplace his/her keys, a “back door” method of re-setting the lock is necessary.

Kwikset designed a re-set cradle to address this situation for their locks. It is relatively complex, has multiple moving parts, and due to it's design objective of eliminating manual dexterity to perform a reset, it can only work with the Kwikset Smartkey™ 12 design.

Schlage, on the other hand, did not design a reset tool for resetting their cylinder without a working key. For the Schlage design, the lock is essentially useless without a working key. Replacement of the lock is necessary since Schlage made no provision for a lost key scenario.

Therefore, since no reset tool for Schlage user resettable locks exists, an invention that can re-set Schlage Securekey locks, and as an additional benefit, other user resettable lock designs as well, would prove highly useful to the locksmith trade.

### BRIEF SUMMARY OF THE INVENTION

It is an object of the present invention to provide a handheld instrument for resetting a Schlage Securekey cylinder 11 when there are no working keys available.

It is another object to provide a single tool that is capable of resetting other user resettable lock designs when there are no working keys available.

It is another object to provide a simple inexpensive design that is one piece with no moving parts that relies on hand dexterity to exact a lock cylinder reset.

In accordance with these objects, the present invention is a simple handheld instrument made to reset multiple user resettable lock designs. The tool is a flat piece of stamped steel long enough for a hand to comfortably grasp with a comb on each end. In the invention's current embodiment, one comb 1 is for resetting Schlage Securekey m cylinders, and the other comb 2 is for Kwikset Smartkey™ cylinders. These two combs are dimensioned differently so that they can enter their corresponding lock cylinder design's access ports and depress the lock slides inside the cylinder to a precise depth. The space between each tine on the comb corresponds to the position of the slides inside the cylinder it engages. Once the tool has depressed the slides, rotation of the cylinder's plug to it's reset position is easily accomplished with the tip of a key or small flat screwdriver. At that point, the new key can be inserted into the cylinder and learned.

### DETAILED DESCRIPTION OF THE PREFERRED EMBODIMENTS

As described in the background section above, user resettable lock designs require a working key to reset the lock. This working key is rotated to a “reset position” where it can be removed and a new key inserted and learned.

This is similar to a computer's password, where changing the password requires knowing the old password to get in. If the user has lost his or her key, a “back door” method of resetting the lock must be performed. Schlage Securekey™ locks do not have a back door device for resetting these locks when there are no working keys. This present invention provides for the rotation to the reset position for the Schlage Securekey™ cylinders 11 when all keys are lost. Also, due to it's simple handheld design, it can reset a Kwikset Smartkey™ cylinder 12 when all keys are lost, as well.

The invention 4, known as The Better Resetter, in it's current embodiment, consists of one piece of flat steel. It is 4-8 inches in length allowing for room to hold the tool. It is 0.1 to 1 inch in width allowing for rigidity. It is 0.001 to 1 inch in thickness allowing it to pass through the lock's access ports, and in it's present embodiment, is 18 gauge stainless steel. Fashioned into each end of this flat piece of steel is a laser cut “comb”. Each comb consists of 5 equally sized and spaced tines. While the two combs are similar, their exact dimensions are tailored to fit the lock design they reset, so each comb is slightly different in the length of the tines, spacing between the tines, and width of the tines. The comb's tines are designed to simultaneously depress the slides inside the lock to a precise depth. Once at this precise depth, the cylinder's plug is unlocked and can be rotated to the reset position where it will accept a new key.

Depressing the 5 slides simultaneously to a precise depth is the instruments' main purpose, and is the “back door” to getting into the lock when all keys are lost. A precisely made comb that holds the slides in an exact position is what effectively unlocks the cylinder allowing rotation of the plug to it's reset position.

Most importantly, and what makes this invention unique, is that the instrument is a hand held device, and not part of a fixture. Because of this, it is able to enter differing cylinder designs with differing form factors, and does not limit the scope of it's utility to a single design. By relying on manual dexterity, the instrument is capable of manipulating lock cylinder designs that are very different from one another.

Since this method of manipulating a user resettable cylinder works with both the Schlage and Kwikset designs, fashioning an instrument with multiple combs onto one instrument makes for a more convenient and useful tool. The user can simply choose the end of the tool that corresponds to the lock design they are working on. This does NOT preclude future embodiments consisting of only one comb or more than two combs per instrument.

In addition, the instrument has a “barb” 3 protruding of one end of the tool. This barb is used to depress the change shuttle inside a Smartkey™ cylinder after it has been rotated to the reset position. Inclusion of this barb eliminates one more tool from the reset process, making for a more useful and convenient tool.

Since this “back door” manipulation of the slides with a comb is shared by both the Schlage and Kwikset designs, it is apparent that future designs may be manipulated by the same process. Therefore, this invention is not intended to be limited to the details shown. Rather, modifications to the number of comb's per tool, tines per comb, and their dimensions may be made staying within the scope and range of the claims and without departing from the invention.

### BRIEF DESCRIPTION OF THE DRAWINGS

FIG. 1 illustrates a device 4 for resetting locks according to the present invention.

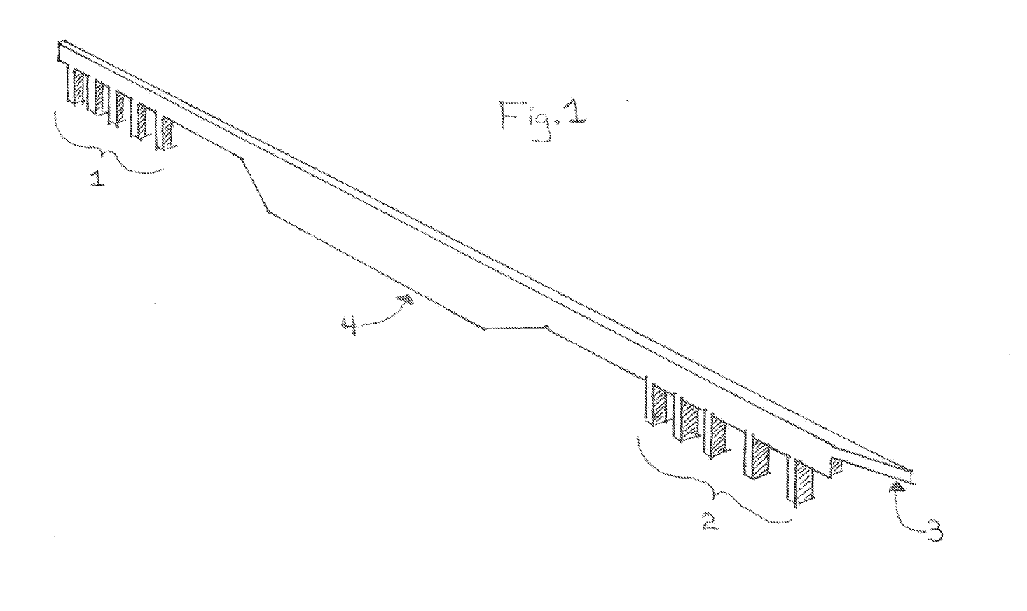

FIG. 2 illustrates the present invention 4 entering the access ports of the cylinder 11 and engaging the slides on a Schlage Securekey™ lock cylinder 11 that is being held in a shop vise 8. In this figure, an SC-1 key blank 6 is first inserted into the lock then the Schlage comb 1 end of the instrument is inserted into the access ports. The key is then removed allowing the spring loaded slides inside the cylinder to rise up and meet the tines of the instrument. The slides are then in alignment for rotation to the reset position.

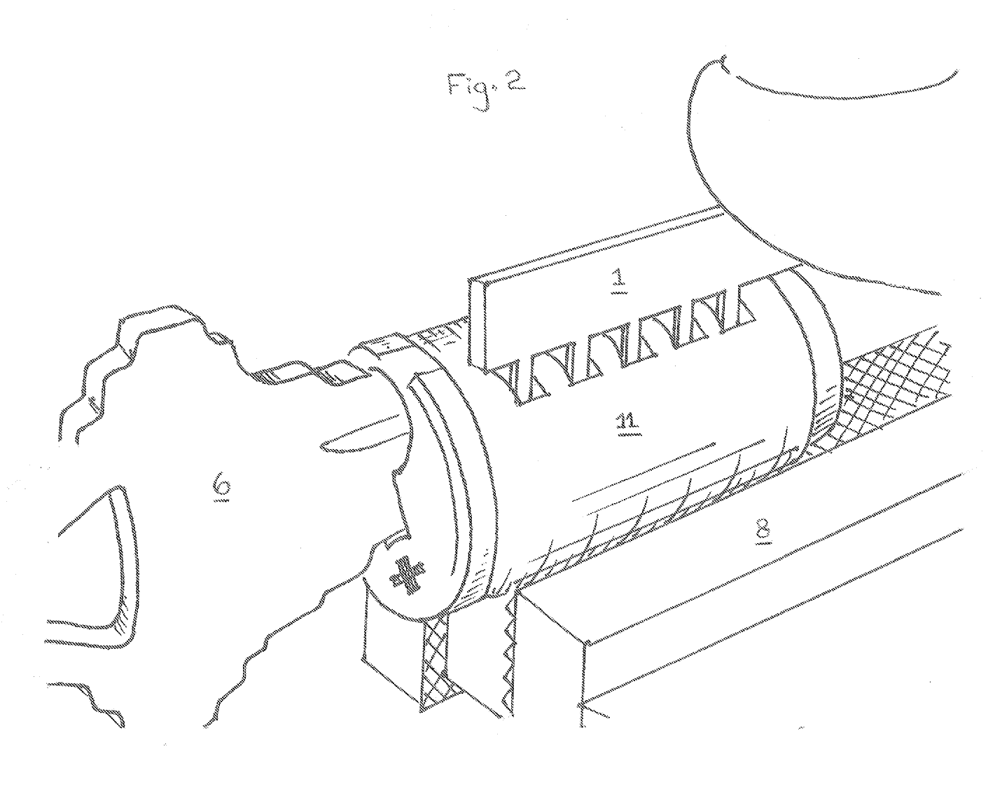

FIG. 3 illustrates the present invention being used to enter the access ports and depress the slides on a Kwikset Smartkey™ lock cylinder 12 that is being held in a shop vise 8. The Kwikset comb 2 directly forces the spring loaded slides inside the lock to a position allowing the cylinder to be turned to it's reset position with a small screwdriver or the tip of a key.

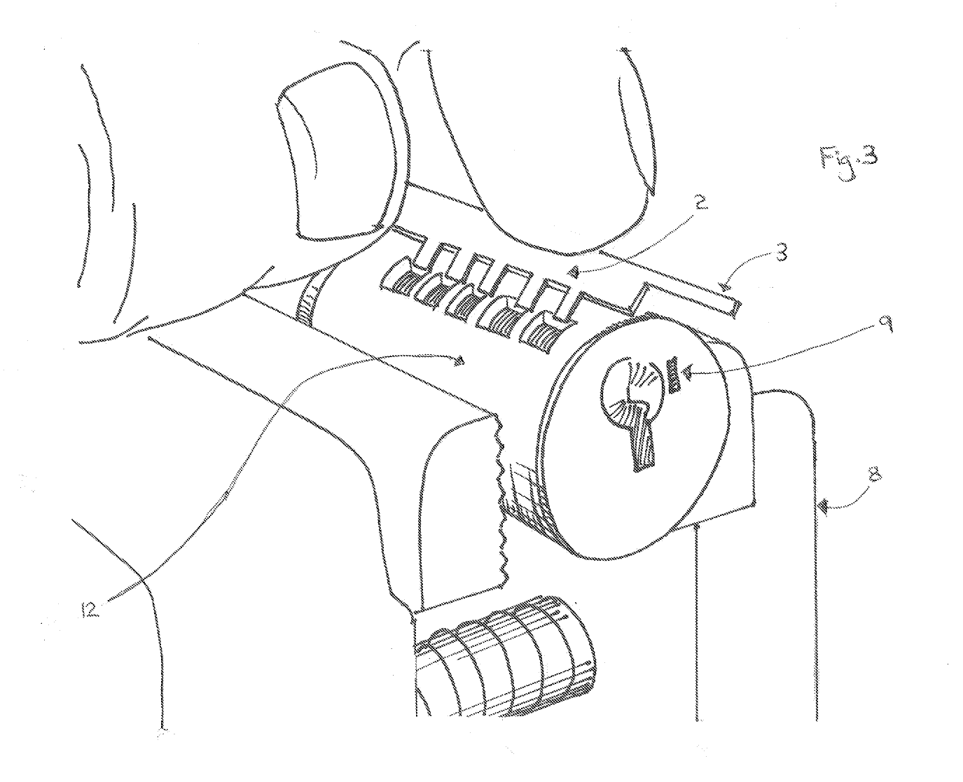

FIG. 4 illustrates a Kwikset Smartkey™ lock cylinder 12 rotated 90 degrees counter clock-wise to it's reset position and the barb 3 on the Kwikset end of the instrument depressing the change shuttle inside the cylinder, through the change shuttle access port 9.

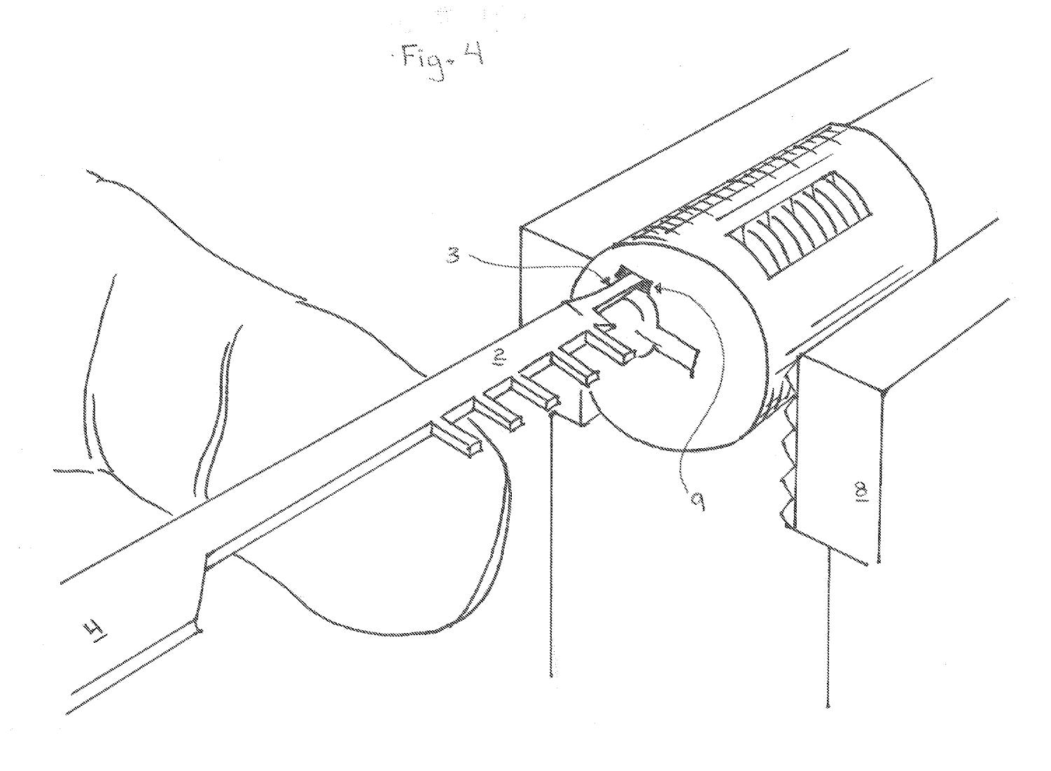

FIG. 5 illustrates a Schlage Securekey™ lock cylinder 11 in it's reset position ready to accept the key you want it to learn.

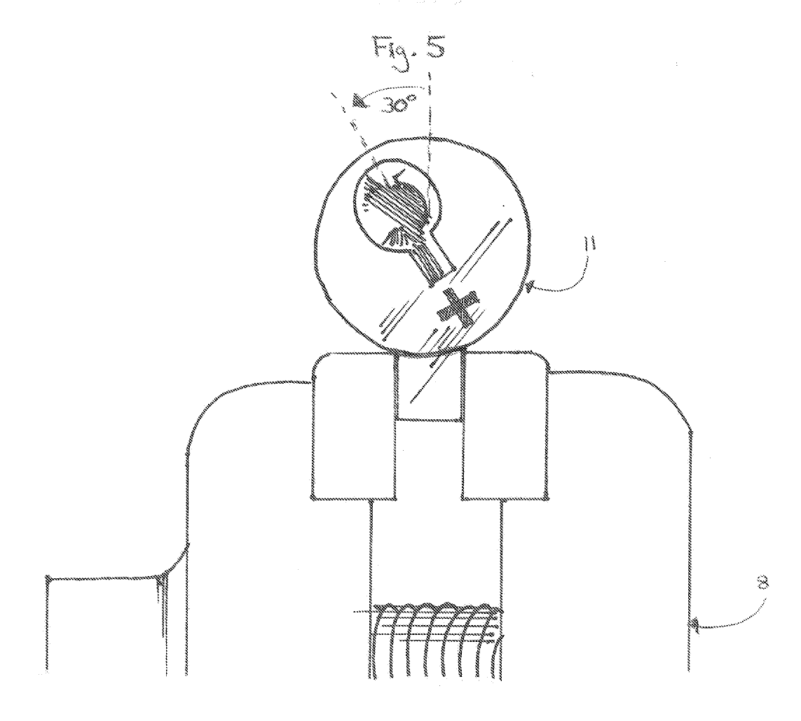

I claim:

1. A handheld instrument 4 for resetting user resettable lock cylinders comprising of:
A graspable handle with one or more combs whose tines are tailored to depress and align the slides inside the lock design it resets to a position allowing for rotation to it's reset position.

2. The instrument according to claim 1, wherein said handle has an opposing barb 3 off one end for depressing a change shuttle.
